(19) United States
(12) Patent Application Publication
(10) Pub. No.: US 2026/0161764 A1
(43) Pub. Date: Jun. 11, 2026

(54) Global Biometric-based Automatic Teller Machine

(71) Applicant: Gokulram Krishnan, Middletown, DE (US)

(72) Inventor: Gokulram Krishnan, Middletown, DE (US)

(21) Appl. No.: 19/218,361

(22) Filed: May 26, 2025

(51) Int. Cl. G06F 21/32; G06Q 20/10

(52) U.S. Cl. CPC G06F 21/32; G06Q 20/1085

(57) ABSTRACT

This nonprovisional utility patent proposes a multi-modal authentication system that uses biometric-based studies to improve the user experience in the Automated Teller Machine, commonly called ATM. The approach creates enhanced privacy, user convenience, and user protection. The concept of biometrics in the financial industry could go beyond the ATM process, as card-based transactions or processing continue to operate globally. This will also potentially change the landscape for even online transactions, where biometrics could be a medium of authentication for transactions made from computers, laptops, or mobile phone applications. The paper proposes the integration of eye-related biometrics, fingerprint details, and handprint details. This integration will provide the authentication application with the option to build a robust authorizing platform, as there is an associated weightage to each of these biometrics that can be scored individually. Biometric-based data and authentication patterns will allow users to perform actions while eliminating the aspect of traditional PIN-based verification.

### BACKGROUND OF THE INVENTION

The Automatic Teller Machine (ATM) is one of the most important inventions in the field of the financial industry—most ATM systems are at a phase where the system should be revisited for the benefit globally. This utility is primarily targeted at the United States of America's ATM system. ATM currently requires the banking customers to physically key in the PIN code, and with technological advancement, the ATM systems can be up for major reform to update the hardware to slowly adapt to the technological advancements.

### SUMMARY OF THE INVENTION

Technology has advanced globally, and the advancement and evolution will continue to empower the financial industry in how financial transactions are processed. A traditional Automatic Teller Machine or ATM is one such evolution. In the late 1960s the version 1 of ATM was launched with an initial set of capabilities, and one of the predominant features of ATM was Account Balance and Cash withdrawals. The deposit was made through a traditional envelope, which gets processed at a central facility. And fast forward to 2025, the ATM as a concept has evolved to an extent where all the banking operations can be independently managed and performed on an ATM without a human banker or teller in the process.

In the late 1960s, the concept of Personal Identification Number, also referred to as PIN, which is required to access the account through an ATM, was patented by James Goodfellow. The initial version of PIN came with risks and limitations, but a lot of credit goes to the initial idea of the concept of ATM combined with PIN. This was a standout innovation of the millennium, as the implementation was a game-changer in the financial industry. The version 1 implementation of PIN was not foolproof, as studies mention that the behavior of sharing the PIN with multiple people creates security concerns. If we encounter the scenario of a forgotten PIN, resetting and recovering a PIN is a tedious and time-consuming process. The recovery process might be delayed or long, with a few recovery and reset requests that might take days.

The approach proposed in this paper provides a solution to have a foolproof ATM experience, removing the current vulnerabilities based on the single authentication mechanism. Multi-modal authentication facilitates using multiple biometric results or behaviors to boost security. This paper has used in-progress patent concepts to build a solution that supports the explanation added as part of the abstract.

A few of the important features that are covered as part of the approach are (1) fingerprint authentication mechanism, (2) IRIS-based authentication mechanism, and (3) Hand authentication to initiate additional authentication. This approach also covers the concept used in a smart home security product.

### BRIEF DESCRIPTION OF DRAWINGS

We have a total of 4 figures to support the nonprovisional utility design.

FIG. 1: Interaction Flow diagram that shows how the interface works for the end-to-end authentication process, including the user and customer interaction with the Automatic Teller Machine console.

FIG. 2 illustrates the overall system design for the ATM and authentication system.

FIG. 3 illustrates the high-level architecture of how we develop the background logic from a software perspective. The data includes raw or unprocessed data, curated data, and aggregated data for analytics. The model life cycle mentioned in the figure covers the most important modules for data science development.

FIG. 4 provides the decision or process outline for an ATM transaction, based on the current state

FIG. 5 provides the decision or process outline for an ATM transaction, based on the proposed or new methodology. The proposal is not to completely decommission the old way of performing the authentication, but to provide an alternate approach that will be more secure.

FIG. 6 provides the high-level software architecture of how the flow occurs for a real-time decision when a banking customer does an ATM transaction.

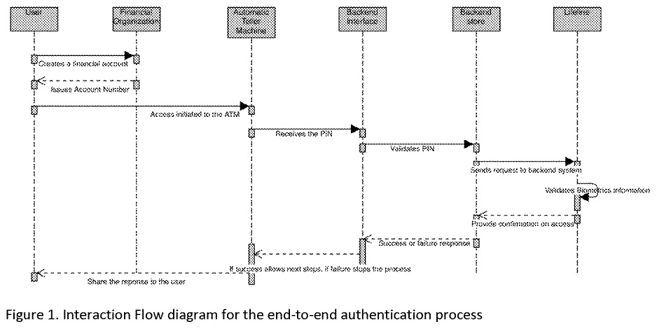

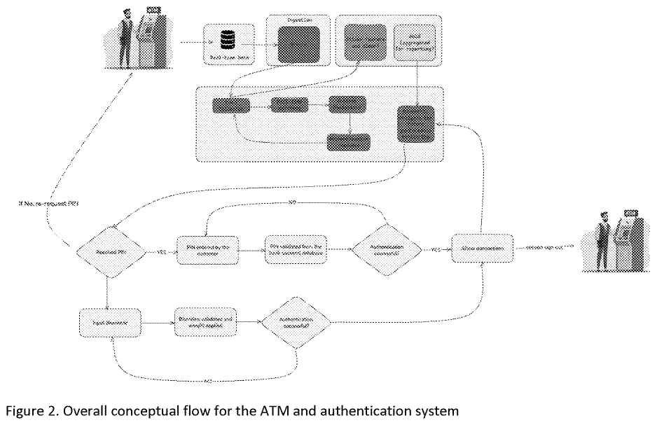

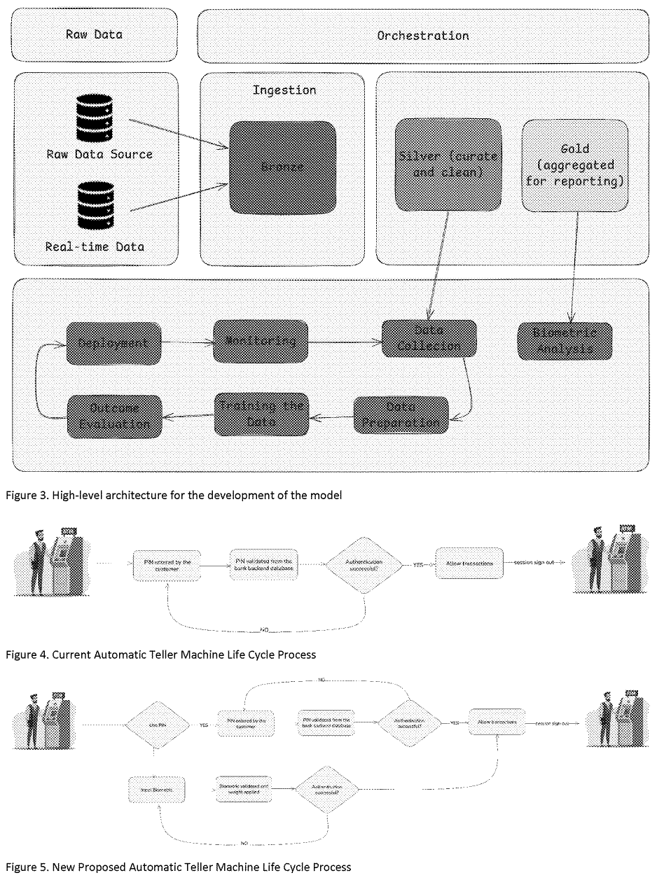

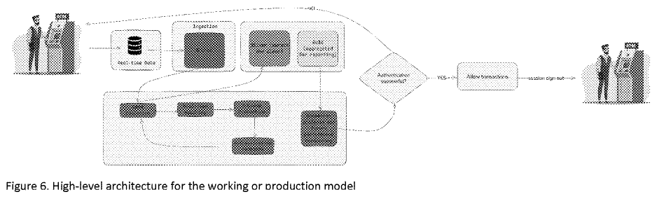

### DETAILED DESCRIPTION OF THE INVENTION

In current days, data privacy and security are getting more prominence. As part of my nonprovisional utility patent, I have designed an approach that would better the experience of ATM transactions for customers, and the proposal takes care of the data privacy and security aspects.

The proposal is to build the ATM logic based on a weightage of the biometric details. We will have three primary biometric information-Eye, fingerprint, and handprint. Based on the weightage for the biometric features, the authentication is enabled or disabled as needed.

It is important to notice that, as part of this proposal, the existing way the ATM works is not completely removed. Banking customers will not be impacted and will not go through any hardships with the new proposed methodology of authentication. The customers will have the option to do a PIN-based authentication or biometric based authentication to perform transactions.

The benefits of the biometric-based authentication are more secure transactions, efficient data privacy, and negligible or zero skimming device-based fraudulent transactions at the ATMs.

### References Cited

### US Patent Documents

U.S. Pat. No. 10,985,090 September 2020 Bolotin et al.
U.S. Pat. No. 5,942,985 August 1999 Chin
U.S. Pat. No. 6,085,090 September 2000 Yee et al.

### Other Publications

1. J. Daugman, “How iris recognition works,” in IEEE Transactions on Circuits and Systems for Video Technology, vol. 14, no. 1, pp. 21-30, January 2004, doi: 10.1109/TCSVT.2003.818350. keywords: {Iris recognition; Pattern recognition; Testing; Pigmentation; Pattern matching; Image databases; Demodulation; Lighting; Ligaments; Entropy},
2. R. Sanchez-Reillo, “Securing information and operations in a smart card through biometrics,” Proceedings IEEE 34th Annual 2000 International Carnahan Conference on Security Technology (Cat. No.00CH37083), Ottawa, ON, Canada, 2000, pp. 52-55, doi: 10.1109/CCST.2000.891166. keywords: {Smart cards; Biometrics; Protection; Authentication; Speaker recognition; Geometry; Prototypes; Speech; Telecommunications; Data structures},
3. A. K. Jain, A. Ross and S. Prabhakar, “An introduction to biometric recognition,” in IEEE Transactions on Circuits and Systems for Video Technology, vol. 14, no. 1, pp. 4-20, Jan. 2004, doi: 10.1109/TCSVT.2003.818349. keywords: {Biometrics; Character recognition; Fingerprint recognition; Robustness; Privacy; Humans; Law enforcement; Databases; Computer science; Pattern recognition},
4. TCL. (2022, Oct. 18). TCL smart door lock: Security right in front of the door. TCL Global Blog. Retrieved from https://www.tcl.com/global/en/blog/tcl-smart-door-lock-security-right-front-door

1. A secure Automatic Teller Machine that comprises an interface that can be used to read customers'biometric data and build an access control interface that can process the biometric data and authenticate user information appropriately, acting as a higher level of security, privacy, and integrity.

2. The upgraded system solution, as recited in claim 0001, will enhance and empower the user experience. It is important to note that the solution will be age-agnostic and will reduce the challenge of the need to remember multiple Personal Identification Numbers, depending on the number of accounts that the customer possesses.

3. The upgraded system solution, as recited in claim 0001, will create an opportunity to make the longevity of the ATM consoles better and optimized, as the biometric way of authentication in the systems reduces the key-based input.

4. The upgraded system solution, as recited in claim 0001, will improve the security of the customer authentication, making the entire process more reliable.

5. The upgraded system solution, as recited in claim 0001, will improve the privacy of the customer authentication, as no unauthorized users will be able to access the accounts just by getting access to the card and the PIN.

6. The upgraded system solution, as recited in claim 0001, will allow banking and financial organizations to avoid fraud that originates from physical ATM centers.

7. The upgraded system solution, as recited in claim 0001, claim 0003, and claim 0006, will allow banking and financial organizations save costs on overall operations and physical hardware through better privacy and better management.

8. The upgraded system solution, as recited in claim 0001, makes the banking and financial organization less prone to identity theft and saves customer identification.

9. The upgraded system solution, as recited in claim 0001, makes the banking and financial organization highly reputable for safeguarding the important economics of customer wealth.

10. The upgraded system solution, as recited in claims 0001, 0006, and 0009, contributes to the improved financial health of the customer and the global financial state with reduced fraudulent transactions.

11. The upgraded system solution, as recited in claim 0001, provides multi-modal biometrics (handprint, fingerprint, Iris) for authentication.

12. The upgraded system solution, as recited in claim 0001, provides a cloud-based Al fraud detection solution for real-time transaction monitoring.

13. The upgraded system solution, as recited in claim 0001, provides a touch-free authentication mechanism that would optimize the overall experience.
